(19) United States
(12) Patent Application Publication
(10) Pub. No.: US 2017/0299753 A1
(43) Pub. Date: Oct. 19, 2017

(54) Metal Detector for Salt Soils

(71) Applicant: Minelab Electronics Pty Limited, Torrensville (AU)

(72) Inventor: Bruce Halcro Candy, Basket Range (AU)

(21) Appl. No.: 15/481,036

(22) Filed: Apr. 6, 2017

Related U.S. Application Data
(63) Continuation of application No. 12/631,604, filed on Dec. 4, 2009, now abandoned.

(30) Foreign Application Priority Data
Dec. 12, 2008 (AU) 2008906401

(51) Int. Cl. G01V 3/10

(52) U.S. Cl. CPC G01V 3/10

(57) ABSTRACT

This invention relates to metal detectors used to detect metal targets in soils wherein the detector is insensitive to signals induced by a received magnetic field due to perpendicular components of a uniform conducting half-space, including metal detectors simultaneously capable of suppressing signals due to components of substantially log-uniform viscous superparamagnetic soil, and including metal detectors using repeating transmit signal cycles resembling a pulse induction-like waveforms. It discloses signal processing, in particular synchronous demodulation functions which may simultaneously substantially suppress signals due to perpendicular components of a uniform conducting half-space in a received magnetic field, signals due to components of substantially log-uniform viscous superparamagnetic soil, and signals due to a movement of the receive coil with respect to a static magnetic field.

### CROSS-REFERENCE TO RELATED APPLICATIONS

This application is a continuation of U.S. patent application Ser. No. 12/631,604, filed on Dec. 4, 2009, which claims the benefit of AU 2008906401, filed Dec. 12, 2008, the contents of each of which is incorporated herein in its entirety by reference.

### TECHNICAL FIELD

This invention relates to metal detectors used to detect metal targets in soils wherein the detector is insensitive to signals induced by a received magnetic field due to perpendicular components of a uniform conducting half-space.

### INCORPORATION BY REFERENCE

The entire content of each of the following documents is hereby incorporated by reference in the present specification: U.S. Pat. No. 5,576,624 entitled ‘Pulse induction time domain metal detector’; U.S. Pat. No. 6,636,044 entitled ‘Ground mineralization rejecting metal detector (receive signal weighting)’; Australian Provisional Patent Application No. 2006903737 entitled ‘Metal detector having constant reactive transmit voltage applied to a transmit coil’; Australian Provisional Patent Application No. 2007906175 entitled ‘Metal detector with improved magnetic response application’; International Patent Application No. PCT/AU2007/001507 entitled ‘Metal detector with improved magnetic soil response cancellation’; International Patent Publication No. WO 2005/047932 entitled ‘Multi-frequency metal detector having constant reactive transmit voltage applied to a transmit coil’.

### BACKGROUND

The general forms of most metal detectors which interrogate soils and samples are either hand-held battery operated units, conveyor mounted units, or vehicle mounted units. Examples of hand-held products include detectors used to locate gold, explosive land mines or ordnance, coins and treasure. Examples of conveyor-mounted units include gold detectors in ore mining operations, and an example of a vehicle-mounted unit includes a unit to locate land mines.

These metal detectors usually consist of transmit electronics generating a repeating transmit signal cycle, which is applied to a transmit coil, which transmits a transmitted magnetic field.

Further, these metal detectors contain receive electronics which processes a received magnetic field to produce an indicator output, the indicator output provides an indication of the presence of at least some metal targets under the influence of the transmitted magnetic field.

Time domain metal detectors usually include switching electronics within the transmit electronics, which switches various voltages from various power sources to the transmit coil for various periods in a repeating transmit signal cycle.

All the above incorporated by reference patents disclose time domain metal detectors or metal detection techniques with either pulse induction or pulse induction-like repeating transmit signal cycle.

Many soils can be classified as salt soils and almost all soils also contain viscous superparamagnetic particles. The effects of both of these soil components, when under the influence of the transmitted magnetic field, may produce large unwanted signals in metal detectors. To maximise metal target detection capability, the signals from both of these soil components are ideally substantially minimised or cancelled, leaving the typically weaker signals from metal targets which may be located deep in the soil medium.

Hitherto, time domain metal detectors, such as those described in the incorporated by reference patents, have been designed to be relatively insensitive to low levels of perpendicular components of a uniform conducting half-space by selective sampling or synchronous demodulation during periods of relatively low rate of change of transmit reactive voltage, and only after a sufficient delay following a suitable transition of the transmit signal voltage (e.g. from a comparatively high voltage to a comparatively low voltage). This technique works very well in such circumstances when perpendicular components of a uniform conducting half-space are small in magnitude relative to those that can be found in many other salt soil mediums, because a signal due to perpendicular components of a uniform conducting half-space decays very rapidly following transitions in the transmit signal voltage, and hence may be insignificant after a delay following transitions in the transmit signal voltage before the said selective sampling or synchronous demodulation during periods of relatively low rate of change of transmit reactive voltage commences.

The ability of prior metal detectors to detect target metals is substantially reduced in conditions where there are relatively high levels of the perpendicular components of a uniform conducting half-space, especially when relatively large search coils (transmit/receive inductors of e.g. >1 m diameter) are used, because the signal due to perpendicular components of a uniform conducting half-space may be so large as to be highly significant, even after the said delay following transitions in the transmit signal voltage before the said selective sampling or synchronous demodulation during periods of relatively low rate of change of transmit reactive voltage commences. This is less of a problem if the said delay is relatively long (e.g. 20 μs), but such long delays adversely affect detection of some target signals with relatively fast decays (that is short time constant) which will be attenuated and possibly not detected. Indeed, large dimension transmit/receive inductors, e.g. >10 m², are routinely used to locate conductive ore bodies.

Signals due to high levels of perpendicular components of a uniform conducting half-space in saline environment, as received by highly sensitive metal detectors, will obscure the relatively smaller signals from small or deeply buried sought-after metal targets. In fact, some saline environments may be intense enough to cause output indicator overload. This invention provides a method and apparatus to substantially reduce received signals due to high levels of the perpendicular components of a uniform conducting half-space caused by saline environments within a soil medium without substantial reduction in sensitivity to sought metal targets.

In a broad aspect of the invention, there is provided a metal detector used for detecting a metallic target in a soil, including: a. transmit electronics having a plurality of switches for generating a repeating transmit signal cycle, the repeating transmit signal cycle including at least a high voltage period followed by a low voltage period, the high voltage period including at least a duration of switched high voltage and the low voltage period including at least a duration of switched low voltage; b. a transmit coil connected to the transmit electronics for receiving the repeating transmit signal cycle and generating a transmitted magnetic field for transmission into the soil; c. a receive coil for receiving a received magnetic field from the soil and providing a received signal induced by the received magnetic field including a signal due to perpendicular components of a uniform conducting half-space in the soil; and receive electronics connected to the receive coil for processing the received signal, the processing including a synchronous demodulation of the received signal using a predetermined synchronous demodulation function after a predetermined time from the beginning of the low voltage period following the high voltage period to produce a synchronous demodulated signal; wherein multiplication factors, including plural signs and plural magnitudes, of the predetermined synchronous demodulation function are used to define four periods of alternating signs to process the received signal received during the low voltage period such that an averaging of synchronous demodulated signals, for more than one repeating transmit signal cycle, specifically cancels, simultaneously, in an indicator output signal indicative of the presence of the metallic target: (a) a signal due to perpendicular components of the uniform conducting half-space, and (b) signals due to resistive components from the soil modelled by k1+k2 log(F), where k1 and k2 are constants, and F is frequency.

### BRIEF SUMMARY OF THE INVENTION

In a broad aspect of the invention, there is provided a metal detector used for detecting a metallic target in a soil, including: a. transmit electronics having a plurality of switches for generating a repeating transmit signal cycle, the repeating transmit signal cycle including at least a high voltage period followed by a low voltage period, the high voltage period including at least a duration of switched high voltage and the low voltage period including at least a duration of switched low voltage; b. a transmit coil connected to the transmit electronics for receiving the repeating transmit signal cycle and generating a transmitted magnetic field for transmission into the soil; c. a receive coil for receiving a received magnetic field from the soil and providing a received signal induced by the received magnetic field including a signal due to perpendicular components of a uniform conducting half-space in the soil; d. receive electronics connected to the receive coil for processing the received signal, the processing including a synchronous demodulation of the received signal using a predetermined synchronous demodulation function after a predetermined time from the beginning of the low voltage period following the high voltage period; and the processing further including an averaging of post synchronous demodulated signals for more than one repeating transmit signal cycle to substantially cancel the signal due to perpendicular components of a uniform conducting half-space in an indicator output signal, the indicator output signal including a signal indicative of the presence of a metallic target in the soil.

In one form, the received signal induced by the received magnetic field further includes a signal due to a movement of the receive coil with respect to a static magnetic field, wherein an integral of the predetermined synchronous demodulation function is substantially zero within the repeating transmit signal cycle, and the averaging of post synchronous demodulated signals for more than one repeating transmit signal cycle further substantially cancels the signal due to a movement of the receive coil with respect to a static magnetic field.

In one form, the received signal induced by the received magnetic field further includes a signal due to components of substantially log-uniform viscous superparamagnetic soil, wherein the averaging of post synchronous demodulated signals for more than one repeating transmit signal cycle further substantially cancels the signal due to components of substantially log-uniform viscous superparamagnetic soil.

In another broad aspect of the invention there is provided a metal detector used for detecting a metallic target in a soil including: a. transmit electronics having a plurality of switches for generating a repeating transmit signal cycle, the repeating transmit signal cycle including at least a high voltage period followed by a low voltage period, the high voltage period including at least a duration of switched high voltage and the low voltage period including at least a duration of switched low voltage; b. a transmit coil connected to the transmit electronics for receiving the repeating transmit signal cycle and generating a transmitted magnetic field for transmission into the soil; c. a receive coil for receiving a received magnetic field from the soil and providing a received signal induced by the received magnetic field including a signal due to perpendicular components of a uniform conducting half-space in the soil, a signal due to components of substantially log-uniform viscous superparamagnetic soil and a signal due to a movement of the receive coil with respect to a static magnetic field; d. receive electronics connected to the receive coil for processing the received signal, the processing including synchronous demodulations of the received signal using predetermined synchronous demodulation functions after a predetermined time from the beginning of the low voltage period following the high voltage period, wherein the synchronous demodulations include a first synchronous demodulation using a first predetermined synchronous demodulation function, and an integral of the first predetermined synchronous demodulation function is substantially zero within the repeating transmit signal cycle; and an averaging of post first synchronous demodulation signals for more than one repeating transmit signal cycle substantially cancels, in a first output signal, the signal due to perpendicular components of a uniform conducting half-space, the signal due to components of substantially log-uniform viscous superparamagnetic soil and the signal due to a movement of the receive coil with respect to a static magnetic field; the synchronous demodulations further include a second synchronous demodulation using a second predetermined synchronous demodulation function, and an integral of the second predetermined synchronous demodulation function is substantially zero within the repeating transmit signal cycle; and an averaging of post second synchronous demodulation signals for more than one repeating transmit signal cycle substantially cancels in a second output signal the signal due to components of substantially log-uniform viscous superparamagnetic soil and the signal due to a movement of the receive coil with respect to a static magnetic field; and the receive electronics linearly combines all the output signals to produce an indicator output signal, the indicator output signal including a signal indicative of the presence of a metallic target in the soil.

In one form, the synchronous demodulations further including a third synchronous demodulation which uses a third predetermined synchronous demodulation function, and an averaging of post third synchronous demodulation signals for more than one repeating transmit signal cycle substantially cancels in a third output signal the signal due to perpendicular components of a uniform conducting half-space and the signal due to components of substantially log-uniform viscous superparamagnetic soil.

In one form, the synchronous demodulations further including a fourth synchronous demodulation which uses a fourth predetermined synchronous demodulation function, and an integral of fourth predetermined synchronous demodulation function is substantially zero within the repeating transmit signal cycle; and an averaging of post fourth synchronous demodulation signals for more than one repeating transmit signal cycle substantially cancels in a fourth output signal the signal due to perpendicular components of a uniform conducting half-space and the signal due to a movement of the receive coil with respect to a static magnetic field.

In one form, the received magnetic field is substantially proportional to t^{-3/2} when a perpendicular component of a uniform conducting half-space is subjected to a single isolated magnetic step function.

In one form, the received magnetic field is substantially proportional to natural log of t when a component of substantially log-uniform viscous superparamagnetic soil is subjected to a single isolated magnetic step function.

In one form, the transmit electronics further maintains substantially constant a reactive voltage across the transmit coil during at least part of the low voltage period.

In one form, the transmit electronics further maintains substantially constant and non-zero a current in the transmit coil during at least part of the low voltage period.

In one form, the transmit electronics further maintains substantially zero current in the transmit coil during at least part of the low voltage period.

In one form, the transmit coil and the receive coil are the same coil.

In one form, the duration of the high voltage period is substantially shorter than the low voltage period.

In one form, an average absolute value of a voltage during the high voltage period is within the range of about 10 volts to about 400 volts.

In one form, an average absolute value of a voltage during the low voltage period is within the range of 0 volts to about 15 volts.

A detailed description of one or more embodiments of the invention is provided below, along with accompanying figures that illustrate, by way of example, the principles of the invention. While the invention is described in connection with such embodiments, it should be understood that the invention is not limited to any embodiment. On the contrary, the scope of the invention is limited only by the appended claims and the invention encompasses numerous alternatives, modifications, and equivalents. For the purpose of example, numerous specific details are set forth in the following description in order to provide a thorough understanding of the present invention. The present invention may be practised according to the claims without some or all of these specific details. For the purpose of clarity, technical material that is known in the technical fields related to the invention has not been described in detail so that the present invention is not unnecessarily obscured.

Throughout this specification and the claims that follow, unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any prior art in this specification is not, and should not be taken as, an acknowledgment or any form of suggestion that such prior art forms part of the common general knowledge of the technical field.

To assist with the understanding of this invention, reference will now be made to the drawings:

### BRIEF DESCRIPTION OF THE DRAWINGS

FIG. 1 depicts a block diagram of one embodiment of the invention;

FIGS. 2A-2C shows examples of various repeating transmit cycle signals applied to the transmit coil;

FIG. 3 shows an example of possible signals within a received signal induced by a received magnetic field during a low voltage period in the repeating transmit signal cycle;

FIG. 4 depicts approximate signals induced by a received magnetic field due to perpendicular components of a uniform conducting half-space and components of substantially log-uniform viscous superparamagnetic soil, in response to a transmitted magnetic field with a single isolated exact magnetic step function. Also depicted is an example of a predetermined synchronous demodulation function;

FIG. 5A-5D shows different multi-synchronous demodulation systems; and

FIG. 6 shows an alternative operation of a multi-synchronous demodulation system.

### DETAILED DESCRIPTION OF THE INVENTION

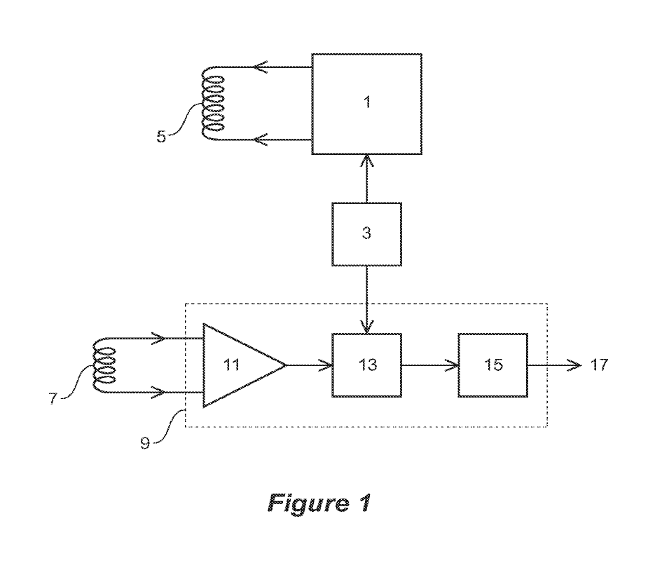

FIG. 1 is a block diagram showing the main parts of a metal detector. Transmit electronics 1 contains switches, and may also include linear elements controlled by timing electronics 3 to generate a repeating transmit signal cycle into a transmit coil 5 connected to the transmit electronics 1. The transmit coil 5 generates, in response to the repeating transmit signal cycle from transmit electronics 1, a transmitted magnetic field, which is directed towards a soil medium (not shown), in which there may be target metals. The physical form of the coil is well known to those skilled in the art and can take many forms.

A receive coil 7 which is located in the vicinity of the soil medium is connected to receive electronics 9, which includes an amplifier 11, synchronous demodulator module 13 and processing electronics 15. The received magnetic field in the receive coil 7 induces a received signal (an electromotive force or emf signal) which is amplified by amplifier 11. Transmit coil 5 and receive coil 7 may be the same coil. Additional processing of the signal may include some filtering action within the receive electronics 9. The amplified signal is provided to a synchronous demodulator module 13, wherein the signal is multiplied by synchronous demodulation functions generated by the timing electronics 3. Post synchronous demodulated signals (output of synchronous demodulator module 13) are further processed by processing electronics 15, the further processing including an averaging of the post synchronous demodulated signals. Based on the output of the averaging process, the processing electronics 15 may apply further signal processing to produce an indicator output signal 17 to indicate the presence of metals within the transmitted magnetic field transmitted by the transmit coil 5.

Some of the functions of the receive electronics 9, such as those performed by the synchronous demodulators and further processing aforementioned, may be implemented in either or both software (such as a Digital Signal Processor (DSP) programmed into an Application Specific Integrated Circuit) or hardware such as an analogue circuit and is typically provided as a combination of software and hardware.

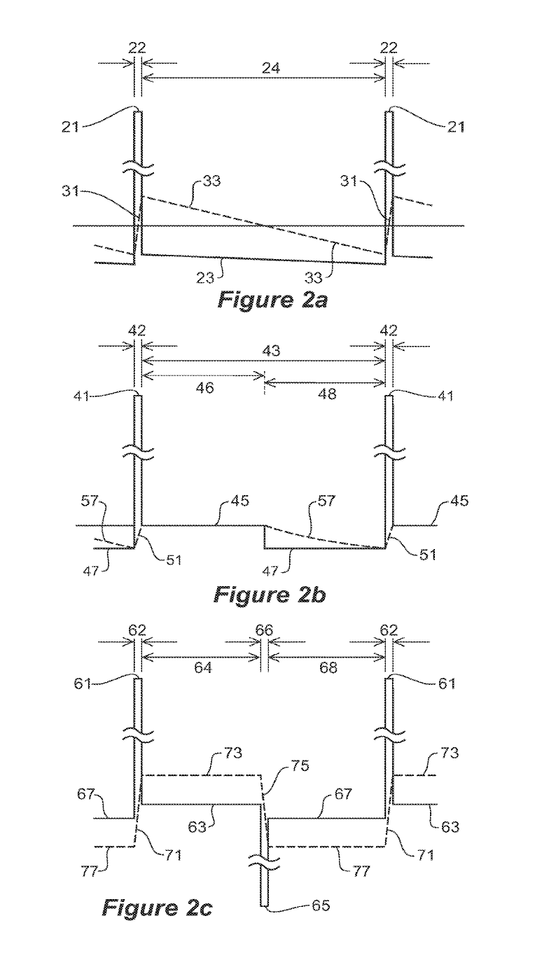

FIGS. 2A to 2C are three examples of suitable repeating transmit signal cycles. A repeating transmit signal cycle is generated by the switching of a power source/s using switches (solid state switches are one example). The power source may include linear elements. The power source includes at least a relatively high voltage output and a relatively low voltage output, and the power source may be in the form of a single unit providing multiple voltage outputs or multiple units each having single or multiple voltage outputs.

In a preferred embodiment, a repeating transmit signal cycle includes at least one relatively short duration high voltage period followed by a low voltage period, as depicted. Each short duration high voltage period causes a rapid change in transmit coil current and is thus a “magnetic step,” and low voltage periods cause the transmit coil current to vary slowly which may include zero change in the magnetic field. A reactive voltage is proportional to the rate of change of current (dI/dt=V/L where I is the transmit coil current, V the transmit coil reactive voltage, and L the effective transmit coil inductance). If the current in the transmit coil is changing in a linear fashion, the reactive voltage across the transmit coil would be a constant value. As the transmitted magnetic field is proportional to the current in the transmit coil, a low voltage period followed by a short duration high voltage period, followed by a low voltage period as shown in FIG. 2 creates an approximate magnetic step.

The useful range for an average absolute value of the voltage during the high voltage period is from about 10 volts to about 400 volts, and the useful range for an average absolute value of the voltage during the low voltage period is from 0 volts to about 15 volts. The average absolute value of the voltage of the high voltage period is relative to the average absolute value of the voltage of the low voltage period. For example, the average absolute value of the voltage of the high voltage period can be 400 volts with the average absolute value of the voltage of the low voltage period being 15 volts. In another example, the average absolute value of the voltage of the high voltage period can be 10 volts with the average absolute value of the voltage of the low voltage period being 0.5 volts. The first example would be used in a hand held metal detector while the second example may be used for very low power metal detectors.

Voltage within a high voltage period or a low voltage period need not be constant throughout the period, as long as the average absolute value of the voltage of the high voltage period is significantly higher (as understood by a person skilled in the art) than the average absolute value of the voltage of the low voltage period. For example, in FIG. 2B, the low voltage period 43 includes a single zero voltage duration 46 and a low voltage duration 48, and thus the average absolute value of the voltage of the high voltage period 42 is higher than the average absolute value of the voltage of the low voltage period 43.

A repeating transmit signal cycle can have more than one high voltage period and low voltage period. For example, there are two high voltage periods (62 and 66) and two respective low voltage periods (64 and 68) in the repeating transmit signal cycle depicted in FIG. 2C.

There can be different types of repeating transmit signal cycle, each type having different levels of the voltage (including reactive voltage) across the transmit coil 5 and different levels of current in the transmit coil 5.

One useful example of a repeating transmit signal cycle is to have the transmit electronics 1 maintain a constant non-zero reactive voltage across the transmit coil 5 during the low voltage period following the high voltage period, and an example is shown in FIG. 2A. In this example, the transmit coil current waveform (31 and 33) is an approximate saw-tooth wave. This waveform results from the switching of a short duration of high voltage 22 having a relatively high voltage 21 (e.g. +200V across the transmit coil) with its associated rapid change of transmit coil current 31, followed by the switching of a low voltage 23 for a period having a relatively low average voltage (e.g. −5V across the transmit coil) and a constant reactive voltage. The low voltage is applied to the transmit coil and a linearly changing transmit coil current 33 results. The slope of the voltage 23 applied to the transmit coil equals the constant reactive voltage divided by the equivalent transmit coil series inductance times the equivalent transmit coil series resistance. For illustration purposes, when the constant reactive voltage is −5V, the equivalent transmit coil series inductance is 0.25 mH and the equivalent transmit series resistance is 0.5Ω the slope of the transmit coil voltage is 5V/0.25 mH×0.5Ω=0.01V/μs. If the period of the constant reactive voltage is 0.2 ms, then the change in voltage over the period is 2V, so in this illustration, the voltage at the commencement of the low voltage period across the transmit coil is −4V and at the termination of the low voltage period is −6V.

In an example of another type of a repeating transmit signal cycle, the transmit electronics 1 maintains substantially zero current in the transmit coil 5 during at least part of the low voltage period following a high voltage period and an example of this is shown in FIG. 2B. In this example, the repeating transmit signal cycle takes the form of a pulse induction transmit waveform with a receive period of zero transmit coil current following a magnetic step. This waveform is formed by a short duration high voltage period 42 with a relatively high voltage 41 (e.g. +200V across the transmit coil) with an associated rapid change of transmit coil current 51. This high voltage period 42 is known as a “back-emf” period in a pulse induction metal detection system and is followed by the low voltage period 43, including a duration of zero voltage and zero transmit coil current 46 and a duration of low voltage 48. The current 57 in the transmit coil increases negatively, during the low voltage duration 48, according to V/R(1-exp(-t/τ)), where V is the effective voltage 47 applied to the transmit coil, R is the effective total series resistance of the transmit coil and the transmit electronics, and ti is the time constant L/R where L is the effective transmit coil series inductance.

In a further example of a repeating transmit signal cycle, the transmit electronics 1 maintains constant and non-zero current in the transmit coil 5 during at least part of the low voltage period following a high voltage period and an example of this is shown in FIG. 2C. In this example, the transmit current (71, 73, 75 and 77) is approximately of a square-wave waveform. This current waveform is formed by a first short high voltage period 62 with a relatively high voltage 61 (e.g. +200V across the transmit coil) with an associated rapid change of transmit coil current 71. This first high voltage period 62 is followed by a first low voltage period 64 where the transmit coil reactive voltage is zero, the transmit coil current 73 is constant and non-zero, and the transmit voltage applied across the transmit coil 63 is finite and constant. The first high voltage period 62 and the first low voltage period 64 are followed by a second high voltage period 66 and a second low voltage period 68, where the second high voltage period 66 and the second low voltage period 68 are the mirror image of the first high voltage period 62 and the second low voltage period 64 in terms of the polarity in voltage, reactive voltage and current. For illustration purposes, in a case of a finite constant voltage across the transmit coil of +1V, and an effective total series resistance of the transmit coil, R, of 0.5Ω the finite constant transmit coil current 73 will be 2 A. Similarly, the finite constant transmit coil current 77 will be −2 A.

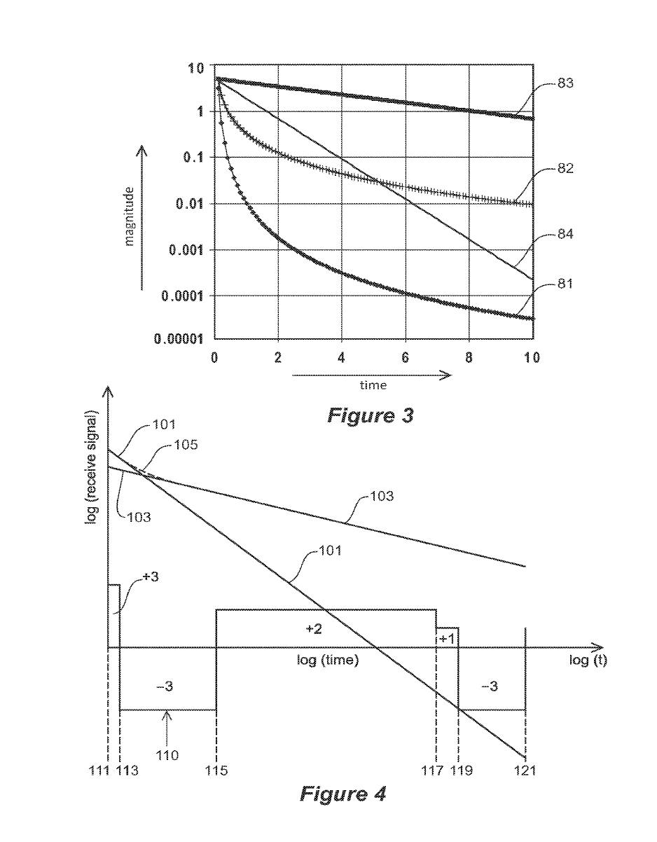

FIG. 3 shows examples of idealised signals within a received signal induced by a received magnetic field during a low voltage period as received from various soil types. These signals are induced by a magnetic step (generated by a high voltage period followed by a low voltage period). When the transmitted magnetic field is transmitted into a soil having a saline environment, a received magnetic field may include a signal 81 due to perpendicular components of a uniform conducting half-space in the soil. The received magnetic field may also include a signal due to parallel components of a uniform conducting half-space in the soil but the perpendicular component is of principal interest in this description of embodiments of the invention because the parallel component is comparatively much weaker.

In theory, the received magnetic field due to a perpendicular component of a uniform conducting half-space when the uniform conducting half-space is subjected to a single isolated exact magnetic step function is substantially proportional to t^{-3/2}. A single isolated exact magnetic step corresponds to a zero reactive voltage of “semi-infinite duration” followed by a single high voltage period of “infinite voltage” for “zero duration” which is followed by a low voltage period of zero constant reactive voltage.

Further in respect to a signal due to perpendicular components of a uniform conducting half-space, a received magnetic field may include a signal 82 due to substantially log-uniform viscous superparamagnetic soil.

In theory, the received magnetic field due to a component of substantially log-uniform viscous superparamagnetic soil when the component of substantially log-uniform viscous superparamagnetic soil is subjected to a single isolated magnetic step function is substantially proportional to the natural logarithm of t.

In addition to a signal due to perpendicular components of a uniform conducting half-space, the received magnetic field may include a signal due to a movement of the receive coil with respect to a static magnetic field, for example field from magnetised rocks or the earth's magnetic field. This signal consists of low frequency components at the inputs to the synchronous demodulators (not shown in FIG. 3).

Further, in addition to a signal due to perpendicular components of a uniform conducting half-space, the received magnetic field may include a signal due to a sought after metal target, for example a gold nugget. An example of a signal due to sought after metal targets with slow decaying time (high time constant) is as depicted as signal 83 and an example of a signal due to sought after metal targets with fast decaying time (low time constant) is as depicted as signal 84.

In this embodiment, signals induced by the received magnetic field are processed after a predetermined delay time from the beginning of the low voltage period. The reason for waiting a predetermined delay time is to allow the signal due to the perpendicular components of a uniform conducting half-space 81 to decay to an acceptable level to avoid too huge an input signal level into the amplifier 11 within the receive electronics 9.

FIG. 4 is a graph of log (time) versus log (received signals or received emf from a receive coil), with no electronic d.c. offset, for a transmitted magnetic field of a single isolated exact magnetic step function. An (unloaded) emf signal induced by a received magnetic field due to perpendicular components of a uniform conducting half-space 101 (proportional to t^{-5/2}) decreases faster than a signal due to components of substantially log-uniform viscous superparamagnetic soil 103 (proportional to t⁻¹). A combination of both 101 and 103 gives a combined signal of 105.

The relative magnitude of the viscous superparamagnetic components to saline components varies considerably from location to location and FIG. 4 is merely an example, and the synchronous demodulation multiplication factor function shown in FIG. 4 is also merely an example.

The predetermined synchronous demodulation function may be determined by solving the simultaneous equations or be determined empirically. In this example, the function takes the form of a rectangular wave with decreasing synchronous demodulation multiplication factor and with varying duration 110. The figure shows, that between times 111 and 113, a synchronous demodulation multiplication factor of +3 is used, between times 113 and 115 a factor of −3, between times 115 and 117 a factor of +2, between times 117 and 119 a factor of +1, and between times 119 and 121 a factor of −3.

To illustrate the principle of this invention in simple terms, the first +3 period is dominated by the signal due to perpendicular components of a uniform conducting half-space for the example shown in FIG. 4. The next following longer −3 period is to cancel most of the +3 contribution of the signal due to perpendicular components of a uniform conducting half-space. The contribution of signal due to perpendicular components of a uniform conducting half-space is typically insignificant in later periods. The following +2 and +1 periods are used to cancel most of the signal due to components of substantially log-uniform viscous superparamagnetic soil during the +3 and −3 periods.

To cancel the signal due to viscous superparamagnetic components as described in PCT/AU2007/001507, which is a signal fitting a model k1+k2 1og(F), where k1 and k2 are constants, and F is frequency, and the signal due to perpendicular components of a uniform conducting half-space simultaneously, the multiplication factor of the synchronous demodulation function chronologically could be of the form of +, −, +, and −, as shown in FIG. 4. The k1 part of the model represents the components of the substantially log-uniform viscous superparamagnetic soil of the present application, and the k2 1og(F) part of the model represents a signal due to substantially log-linear frequency-dependent resistive components of viscous superparamagnetic soil.

To cancel the signal due to viscous superparamagnetic components as described in PCT/AU2007/001507 and the signal due to perpendicular components of a uniform conducting half-space simultaneously, the multiplication factor of the synchronous demodulation function chronologically could be of the form of +, −, +, and −, as shown in FIG. 4.

The received signal from a more complex repeating transmit signal cycle applied to the transmit coil over time is quite complex to represent mathematically, but is mostly dominated by the last magnetic step of the repeating transmit signal cycle, especially in the case where the low voltage period following the magnetic step includes a period of constant or zero transmit reactive voltage.

The output signal of the synchronous demodulation is input to the processing electronics 15. Further filtering, as known to those skilled in the art, may be carried out within the processing electronics 15. The processing electronics 15 averages the output signals of the synchronous demodulation over a period of time, normally spanning more than one repeating transmit signal cycle and generally many tens of repetitions. This period of time may also be controlled by an operator.

The synchronous demodulation function together with the averaging by the processing electronics can substantially suppress any one of or any combination of the signal/s due to perpendicular components of a uniform conducting half-space in the soil, the signal due to components of substantially log-uniform viscous superparamagnetic soil and the signal due to a movement of the receive coil with respect to a static magnetic field but substantially retain any sought after target signal in an output indicator signal, the output signal indicative of the presence of a metallic target in the soil.

In practice, when applying the teachings of this invention for metal detection in soils having a saline environment, a signal due to perpendicular components of a uniform conducting half-space in the soil, a signal due to components of substantially log-uniform viscous superparamagnetic soil and a signal due to a movement of the receive coil with respect to a static magnetic field need to be cancelled simultaneously. The repeating transmit signal cycle can be any of the methods and implementing systems disclosed in the cited patents including basic pulse induction, and further including a variety of repeating transmit signal cycles as disclosed above and others. The multiplication factors for the synchronous demodulation function could be similar to the example above, in the form of +, −, +, (or its inverse) or +, −, +, − for low voltage periods, or any other form regarded as relevant by a person skilled in the art.

However, as the electronics and/or the synchronous demodulation function are not perfect, the output signal of the embodiment described above would not be completely free of the undesirable signals, such as the signal due to perpendicular components of a uniform conducting half-space in the soil, the signal due to components of substantially log-uniform viscous superparamagnetic soil and the signal due to a movement of the receive coil with respect to a static magnetic field.

Hence, another embodiment of this invention aims to further improve the output signal by using at least one extra synchronous demodulator. The at least one extra synchronous demodulator measures one of the undesirable signals. The processing electronics then measures the amount of the measured undesirable signals within the output signal, so that that amount of undesirable signals can be subtracted from the output signal indicative of the presence of a metallic target in the soil.

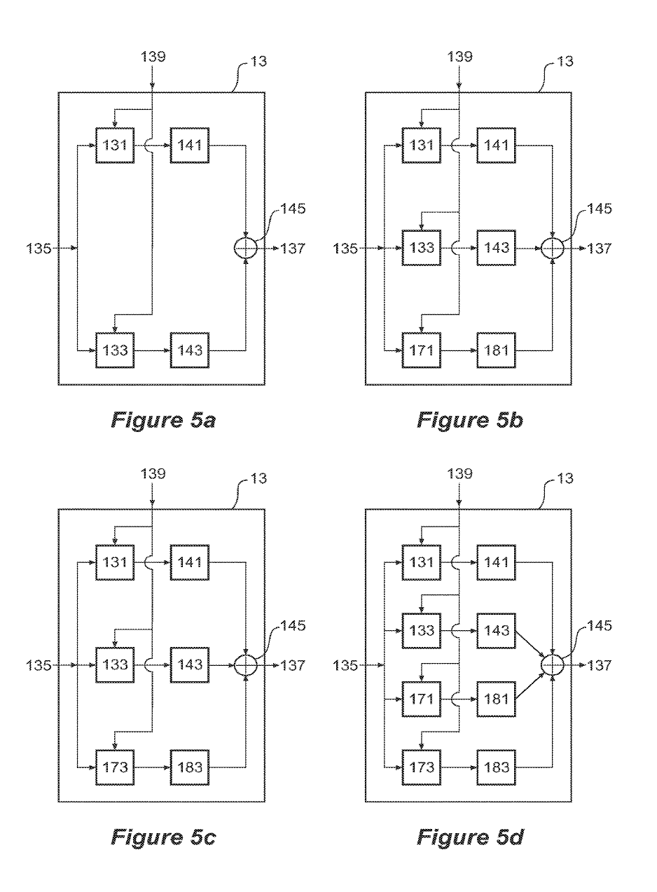

One embodiment to achieve this uses two synchronous demodulators within the synchronous demodulator module 13 as depicted in FIG. 5A. Both synchronous demodulators (a first synchronous demodulator 131 and a second synchronous demodulator 133) are controlled by signals (including predetermined synchronous demodulation functions) 139 supplied from timing electronics 3 to process an input signal 135. The first synchronous demodulator 131 uses a first predetermined synchronous demodulation function and the second synchronous demodulator 133 uses a second predetermined synchronous demodulation function.

The aim of the first synchronous demodulation by first synchronous demodulator 131 together with the averaging of post first synchronous demodulation signals by the averager 141 is to suppress the signal due to perpendicular components of a uniform conducting half-space in the soil, the signal due to components of substantially log-uniform viscous superparamagnetic soil and the signal due to a movement of the receive coil with respect to a static magnetic field.

The aim of the second synchronous demodulation by second synchronous demodulator 133 together with the averaging of post second synchronous demodulation signals by the averager 143 is to suppress the signal due to components of substantially log-uniform viscous superparamagnetic soil and the signal due to a movement of the receive coil with respect to a static magnetic field but not the signal due to perpendicular components of a uniform conducting half-space in the soil.

The averaged outputs of the post first and second synchronous demodulation signals (output of the averagers 141 and 143) are then linearly combined using different coefficients by the processing electronics 145 to produce an indicator output signal 137 indicative of the presence of a metallic target in the soil.

The coefficient applied to the output of the averager 141 is usually unity while the coefficient applied to the output of the averager 143 is determined through the measurement of the amount of the output of the averager 143 (which contains signals due to perpendicular components of a uniform conducting half-space in the soil) within the output of the averager 141 (which also contains small amount of signals due to perpendicular components of a uniform conducting half-space in the soil due to imperfect electronics).

Alternatively, the output of the averager 141 can be correlated with the output of the averager 143 by dividing the output of the averager 141 by the output of the averager 143 to produce a quotient. An averaging of the quotient (e.g. 0.01) is then used as the coefficient for processing of the output of the averager 143.

Thus, when the output of the averager 143 is linearly combined with the output of the averager 141, the residual undesirable signals within the output of the averager 141 due to imperfect electronics (in this case the residual of the signal due to perpendicular components of a uniform conducting half-space in the coil) can be further suppressed or even removed.

As depicted in FIG. 5B, in addition to the first and second synchronous demodulators, the receive electronics can have a third synchronous demodulator 171 using a third predetermined synchronous demodulation function in 139. The aim of the third synchronous demodulation by third synchronous demodulator 171 together with the averaging of post third synchronous demodulation signals by the averager 181 is to suppress the signal due to components of substantially log-uniform viscous superparamagnetic soil and the signal due to perpendicular components of a uniform conducting half-space in the soil but not the signal due to a movement of the receive coil with respect to a static magnetic field.

The averaged outputs of the post first, second and third synchronous demodulation signals (the output of the averagers 141, 143 and 181 respectively) will then be linearly combined with different coefficients by the processing electronics 145 to produce an indicator output signal 137 indicative of the presence of a metallic target in the soil. The coefficient to be applied to the output of the averager 181 can be determined in a similar way to that of the methods described above.

Alternatively, as depicted in FIG. 5C, in addition to the first and second synchronous demodulators, the receive electronics can have a fourth synchronous demodulator 173 using a fourth predetermined synchronous demodulation function in 139. The aim of the fourth synchronous demodulation by fourth synchronous demodulator 173 together with the averaging of post second synchronous demodulation signals by the averager 183 is to suppress the signal due to perpendicular components of a uniform conducting half-space and the signal due to a movement of the receive coil with respect to a static magnetic field but not the signal due to components of substantially log-uniform viscous superparamagnetic soil.

The averaged outputs of the post first, second and fourth synchronous demodulation signals (the output of the averagers 141, 143 and 183 respectively) will then be linearly combined with different coefficients by the processing electronics 145 to produce an indicator output signal 137 indicative of the presence of a metallic target in the soil. The coefficient to be applied to the output of the averager 183 can be determined in a similar way to that of the methods described above.

In yet another embodiment, as depicted in FIG. 5D, the synchronous demodulation module 13 contains the first, second, third and fourth synchronous demodulators and the averaged outputs of the post first, second and fourth synchronous demodulation signals (the output of the averagers 141, 143, 181 and 183 respectively) will then be linearly combined with different coefficients by the processing electronics 145 to produce an indicator output signal 137 indicative of the presence of a metallic target in the soil. The way to determine coefficients for the output of the averagers 141, 143, 181 and 183 are as described above.

FIGS. 5A to 5D shows block diagrams of processes. These processes can be performed by software and hardware arrangements known to a person skilled in the art.

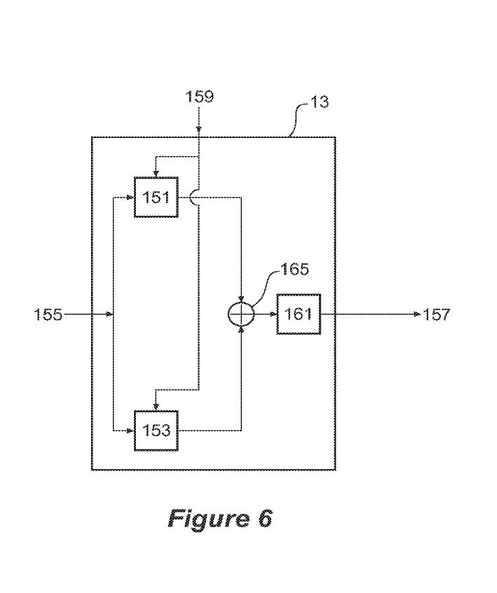

In the discussion above in relation to synchronous demodulation module 13 involving multiple synchronous demodulators, the post synchronous demodulated signals derived using different synchronous demodulation functions by different demodulators are averaged separately before being linearly combined using different coefficients determined by any one of the methods described above. Another possible approach is to linearly combine the outputs of different synchronous demodulators based on an input containing all the undesirable signals (e.g. post first synchronous demodulation signals and post second synchronous demodulation signals) using coefficients determined by any one of the methods described above prior to the averaging of the combined signal. An example is shown in FIG. 6, which consists of two synchronous demodulators (151 and 153). These synchronous demodulators process an input signal 155 using different synchronous demodulation functions through 159 from timing electronics 3. The post synchronous demodulated signals are then linearly combined by electronics 165 prior to averaging 161 to produce an indicator output signal 157 indicative of the presence of a metallic target in the soil. This method can also be applied to any one of the arrangement illustrated in FIGS. 5A to 5D.

1. A metal detector used for detecting a metallic target in a soil including:
a. transmit electronics having a plurality of switches for generating a repeating transmit signal cycle, the repeating transmit signal cycle including at least a high voltage period followed by a low voltage period, the high voltage period including at least a duration of switched high voltage and the low voltage period including at least a duration of switched low voltage;
b. a transmit coil connected to the transmit electronics for receiving the repeating transmit signal cycle and generating a transmitted magnetic field for transmission into the soil;
c. a receive coil for receiving a received magnetic field from the soil and providing a received signal induced by the received magnetic field; and
d. receive electronics connected to the receive coil for processing the received signal, the processing including a synchronous demodulation of the received signal using a predetermined synchronous demodulation function after a predetermined time from the beginning of the low voltage period following the high voltage period to produce a synchronous demodulated signal; wherein multiplication factors, including plural signs and plural magnitudes, of the predetermined synchronous demodulation function are used to define four periods of alternating signs to process the received signal received during the low voltage period such that an averaging of synchronous demodulated signals, for more than one repeating transmit signal cycle, specifically cancels, simultaneously, in an indicator output signal indicative of the presence of the metallic target: (a) a signal due to perpendicular components of the uniform conducting half-space, and (b) signals due to resistive components from the soil modelled by k1+k2 log(F), where k1 and k2 are constants, and F is frequency.

2. The metal detector according to claim 1, wherein the received signal induced by the received magnetic field further includes a signal due to a movement of the receive coil with respect to a static magnetic field, wherein an integral of the predetermined synchronous demodulation function is zero within the repeating transmit signal cycle, and the averaging of the synchronous demodulated signals, for more than one repeating transmit signal cycle, further cancels the signal due to a movement of the receive coil with respect to a static magnetic field.

3. The metal detector according to claim 1, wherein the transmit electronics further maintains constant a reactive voltage across the transmit coil during at least part of the low voltage period.

4. The metal detector according to claim 1, wherein the transmit electronics further maintains constant and non-zero a current in the transmit coil during at least part of the low voltage period.

5. The metal detector according to claim 1, wherein the transmit electronics further maintains zero current in the transmit coil during at least part of the low voltage period.

6. The metal detector according to claim 1, wherein the duration of the high voltage period is shorter than that of the low voltage period.

7. The metal detector according to claim 1, wherein an average absolute value of a voltage during the high voltage period is within the range of about 10 volts to about 400 volts.

8. The metal detector according to claim 1, wherein an average absolute value of a voltage during the low voltage period is within the range of 0 volts to about 15 volts.

9. The method for detecting a metallic target in a soil including the steps of:
generating a repeating transmit signal cycle, the repeating transmit signal cycle including at least a high voltage period followed by a low voltage period, the high voltage period including at least a duration of high voltage and the low voltage period including at least a duration of low voltage;
generating a transmitted magnetic field for transmission into the soil based on the repeating transmit signal cycle;
receiving a received magnetic field from the soil;
producing a received signal induced by the received magnetic field from the soil; and
synchronous demodulating the received signal using a predetermined synchronous demodulation function after a predetermined time from the beginning of the low voltage period following the high voltage period; wherein multiplication factors, including plural signs and plural magnitudes, of the predetermined synchronous demodulation function are used to define four periods of alternating signs to process the received signal received during the low voltage period such that an averaging of synchronous demodulated signals, for more than one repeating transmit signal cycle, specifically cancels, simultaneously, in an indicator output signal indicative of the presence of the metallic target: (a) a signal due to perpendicular components of the uniform conducting half-space, and (b) signals due to resistive components from the soil modelled by k1+k2 log(F), where k1 and k2 are constants, and F is frequency.

10. A non-transitory computer readable medium comprising instructions for causing a processor to implement the steps of:
processing a received signal induced by a magnetic field received from soil; and
synchronously demodulating the received signal using a predetermined synchronous demodulation function after a predetermined time from the beginning of a low voltage period following a high voltage period,
wherein multiplication factors, including plural signs and plural magnitudes, of the predetermined synchronous demodulation function are used to define four periods of alternating signs to process the received signal received during the low voltage period such that an averaging of synchronous demodulated signals, for more than one repeating transmit signal cycle, specifically cancels, simultaneously, in an indicator output signal indicative of the presence of the metallic target: (a) a signal due to perpendicular components of the uniform conducting half-space, and (b) signals due to resistive components from the soil modelled by k1+k2 log(F), where k1 and k2 are constants, and F is frequency.

11. A metal detector used for detecting a metallic target in a soil including:
a. transmit electronics having a plurality of switches for generating a repeating transmit signal cycle, the repeating transmit signal cycle including at least a high voltage period followed by a low voltage period, the high voltage period including at least a duration of switched high voltage and the low voltage period including at least a duration of switched low voltage;
b. a coil connected to the transmit electronics for receiving the repeating transmit signal cycle and generating a transmitted magnetic field for transmission into the soil and for receiving a received magnetic field from the soil and providing a received signal induced by the received magnetic field; and
c. receive electronics connected to the coil for processing the received signal, the processing including a synchronous demodulation of the received signal using a predetermined synchronous demodulation function after a predetermined time from the beginning of the low-voltage period following the high-voltage period to produce a synchronous demodulated signal; wherein multiplication factors, including plural signs and plural magnitudes, of the predetermined synchronous demodulation function are used to define four periods of alternating signs to process the received signal received during the low voltage period such that an averaging of synchronous demodulated signals, for more than one repeating transmit signal cycle, specifically cancels, simultaneously, in an indicator output signal indicative of the presence of the metallic target: (a) a signal due to perpendicular components of the uniform conducting half-space, and (b) signals due to resistive components from the soil modelled by k1+k2 log(F), where k1 and k2 are constants, and F is frequency.

12. The metal detector according to claim 1, wherein the multiplication factors are selected such that a signal due to log-linear frequency-dependent resistive components of viscous superparamagnetic soil is not specifically cancelled.

13. The metal detector according to claim 1, wherein k1 represents log-uniform resistive signal components and k2 log(F) represents log-linear frequency-dependent resistive signal components.

14. The metal detector according to claim 1, wherein the plural magnitudes include at least two different magnitudes.
